(19) United States
(12) Patent Application Publication
(10) Pub. No.: US 2011/0241581 A1
(43) Pub. Date: Oct. 6, 2011

(54) VEHICLE HAVING A POWER SUPPLY DEVICE FOR AN ELECTRIC MOTOR AND METHOD FOR SUPPLYING POWER TO THE ELECTRIC MOTOR

(76) Inventors: Stefan Flock, Rottenbach (DE); Gerhard Hiemer, Nurnberg (DE); Uwe Krella, Nurnberg (DE)

(21) Appl. No.: 13/139,352

(22) PCT Filed: Nov. 25, 2009
(86) PCT No.: PCT/EP09/65808

§ 371 Date: Jun. 13, 2011

(30) Foreign Application Priority Data
Dec. 11, 2008 (DE) 10 2008 061 585.4

(51) Int. Cl. H02P 6/24; H01R 43/00

(52) U.S. Cl. 318/400.3; 29/825

(57) ABSTRACT

A vehicle has a power supply device (1) for an electric motor (7) and a method provides for supplying power to the electric motor (7). Another method produces an intermediate storage device (9) for the vehicle power supply device (1). The vehicle additionally has a vehicle battery (8), the intermediate storage device (9), and a converter (10) for supplying power to the electric motor (7). The intermediate storage device (9) is arranged between the vehicle battery (8) and the converter (10). The intermediate storage device (9) has an intermediate storage module (11) having an integrated discharge device (12), wherein the discharge device (12) converts the stored electric energy into heat energy upon discharging the intermediate storage device (9).

### CROSS-REFERENCE TO RELATED APPLICATIONS

This application is a U.S. National Stage Application of International Application No. PCT/EP2009/065808 filed Nov. 25, 2009, which designates the United States of America, and claims priority to German Application No. 10 2008 061 585.4 filed Dec. 11, 2008, the contents of which are hereby incorporated by reference in their entirety.

### TECHNICAL FIELD

The invention relates to a vehicle having a power supply device for an electric motor and a method for supplying power to the electric motor. The invention further relates to a method for manufacturing an intermediate storage device for the vehicle power supply device. The vehicle additionally has a vehicle battery, the intermediate storage device and a converter for supplying power to the electric motor.

### BACKGROUND

A power supply device of said kind is required for controlling and regulating electric motors of the most diverse design types with the aid of a corresponding power supply network in the vehicle. In particular, such power supply devices are used for regulating and controlling three-phase electric motors with the aid of a variable three-phase network. For the purpose of generating such rotating fields, it is usual for frequency converters in a voltage link to be used as converters, as shown by a schematic representation in FIG. 5. A coil or capacitor C can be used as an intermediate store 13 of the intermediate storage device 9. As shown in FIG. 4, a DC link capacitor 14 is preferably used as an energy store in the intermediate storage device 9.

Such DC link capacitors 14 of the intermediate storage device 9 are also known as power capacitors. In this case the dimensioning of the capacitance of such DC link capacitors 14 is determined according to the following criteria:
1. Current-carrying capacity of the DC link capacitor 14,
2. Voltage ripple within the intermediate storage device 9.

In practice values from 0.15 A to 0.25 are provision is made for A as superimposed so-called ripple current AC per μF (microfarad) capacitance, e.g. in the case of foil capacitors. In the case of vehicles having hybrid and electric drives, phase currents of up to 300 A should effectively be provided. This results in capacitance values of up to 2000 μF. A maximum voltage of approximately 430 V in the intermediate storage device 9 results in an energy E=0.5×C×U² of approximately 185 Ws, which is then stored in the intermediate store 13 or in the DC link capacitor 14.

Outside of the operating period of the vehicle, such stored energy, and also at such high voltages besides, must not be allowed to remain in a storage element any longer, since this jeopardizes the safety of the vehicle. In particular, the terminal points 27 and 28 of the load, such as the frequency converter 10 with attached electric motor 7 (via corresponding supply lines 29, 30 and 31 to a three-phase motor 32 shown in FIG. 4), can be interrupted in the event of an accident. In such an event, the terminal points 27 and 28 of the intermediate storage device 9 are exposed and can cause dangerous discharge sparks.

In order to avoid these dangers, corresponding standards stipulate that power capacitors such as those provided in the intermediate storage device 9 must be equipped with permanently connected discharge devices. For this purpose discharge devices 12 are attached via the terminal points 27 and 28 shown in FIG. 6 in order to discharge the DC link capacitor 14. They must therefore be suitable for absorbing and dissipating the energy stored in the DC link capacitor. This can be done in a passive way, as shown in FIG. 6, via a high-impedance resistor 16 between e.g. 30 kΩ and 50 kΩ (kilo-ohms). During this passive discharge via a discharge resistor 16, the latter is switched in continuously in parallel via the terminal points 27 and 28. However, this involves discharge times lasting several minutes, which are unacceptable for the vehicle technology, especially since the discharge times should be within a few seconds.

Instead of a slow and continuous high-impedance discharge via a resistor, FIG. 7 shows a discharge device 12 which can be clamped onto the terminal points 27 and 28 of the intermediate storage device 9. This discharge device has a low-impedance resistor R via which higher discharge currents can flow in the shortest possible time, but which is only switched in (via a suitable discharge switching element 17 which is illustrated as switch S₂ in FIG. 6) when the operation of the vehicle is interrupted or stopped. However, these systems as shown in FIGS. 5 to 7 cannot be used in motor vehicles due to the restricted installation space in motor vehicles and on account of more stringent safety requirements for motor vehicles. Thus, for example, it is not permitted for any voltage-conducting parts, in particular leads or components of leads which are likely in the charged state to discharge sparks in the event of a rear-end collision, to be exposed in the case of a vehicle accident.

The publication DE 10 2004 057 693 A1 discloses a device for rapidly discharging a capacitor, in particular for rapidly discharging a DC link capacitor. This is connected to a starter generator as an electrical machine and to associated voltage converters via a direct current converter in a vehicle electrical system. The DC voltage converter in this case takes the form of a controlled or regulated DC voltage converter whose output voltage in the vehicle electrical system is increased relative to the normal state after the electrical machine is disconnected and the inverter is switched off, whereby the charges that must be dissipated are supplied to the battery which is connected to the voltage converter.

Such a known intermediate storage device with discharge device, wherein the stored energy is returned to the vehicle battery, has the disadvantage that in the event of a vehicle accident a plurality of connecting leads can be interrupted or destroyed, such that any discharge of a DC link capacitor to the vehicle battery is no longer possible, and therefore an electrical energy storage element can cause significant consequential damage following a vehicle accident. Other proposed means of recovering the stored energy of a DC link capacitor are likewise always associated with the danger that corresponding leads for this purpose must be installed in the vehicle, wherein said leads cannot guarantee that the discharging of the energy stores will be ensured in the event of an accident, and this represents an unacceptable safety hazard.

### SUMMARY

According to various embodiments, a vehicle having a power supply device for an electric motor can be provided, wherein said power supply device has an automatically self-discharging intermediate storage device and therefore overcomes the disadvantages of devices for rapidly discharging capacitors as known from the prior art.

According to an embodiment, a vehicle having a power supply device for an electric motor, may comprise: a vehicle battery; an intermediate storage device; a converter for supplying power to the electric motor; wherein the intermediate storage device is arranged between the vehicle battery and the converter, and the intermediate storage device has an intermediate storage module with an integral discharge device, wherein said discharge device converts the stored electrical energy into thermal energy when the intermediate storage device is discharged.

According to a further embodiment, the intermediate storage device may have a DC link capacitor as an intermediate store. According to a further embodiment, the intermediate storage module may have a common housing for the following components: the DC link capacitor, an electrical resistor, a discharge switching element which has an open position during the charging and storage process and a closed position during the discharging of the DC link capacitor, an electronic driver for holding the discharge switching element open during the charging and storage process and for closing the same if the vehicle engine fails or is turned off. According to a further embodiment, the DC link capacitor can be a foil capacitor and the electrical resistor is a foil resistor which interacts with the discharge device. According to a further embodiment, the foil capacitor may have two large-surface collector electrodes and corresponding storage electrodes, and at least one electrode carries a foil resistor which is arranged in a planar manner on one of the electrodes in a meander-shaped structure. According to a further embodiment, an integrated circuit comprising the discharge switching element and the electronic driver can be arranged on one of the collector electrodes. According to a further embodiment, the DC link capacitor can be a stacked multilayer capacitor or a wound capacitor or a ceramic capacitor. According to a further embodiment, the DC link capacitor can be an A1 electrolytic capacitor. According to a further embodiment, the electrical resistor can be a thin-film resistor or a thick-film resistor on ceramic.

According to another embodiment, a method for manufacturing an intermediate storage device may comprise the following method steps: providing a DC link capacitor comprising at least one surface collector electrode; applying an insulating layer to the collector electrode; applying a wiring structure to the insulating layer; mounting an electrical resistor on a region of the insulating layer and connecting it to the wiring structure; mounting a discharge switching element on the insulating layer and connecting it to the wiring structure; mounting an electronic driver on the insulating layer and connecting it to the wiring structure.

According to yet another embodiment, a method for supplying power to an electric motor of a vehicle, may comprise the following method steps: opening a discharge switching element of a capacitive intermediate store; charging the capacitive intermediate store while interacting with a vehicle battery;
converting the stored energy into an alternating current and supplying power to the electric motor; disconnecting or stopping the vehicle engine and discharging the electrical energy of the capacitive intermediate store by switching in an electrical resistor which is arranged together with the DC link capacitor in a common intermediate storage module.

According to a further embodiment of the above method, the switching-in of an electrical resistor can be effected by means of a discharge switching element which is integrated in the intermediate storage module and an electronic driver. According to a further embodiment of the method, during the discharging process of the intermediate storage device, the stored electrical energy can be converted into thermal energy. According to a further embodiment of the method, electrical energy can be temporarily stored in a DC link capacitor. According to a further embodiment of the method, a discharge switching element may assume an open position during the charging and storage process and a closed position when discharging the DC link capacitor, wherein an electronic driver holds the discharge switching element open during the charging and storage process and holds it closed if the vehicle engine fails or is turned off.

### BRIEF DESCRIPTION OF THE DRAWINGS

The invention is now explained in greater detail with reference to the appended figures, in which:

FIG. 1 shows a schematic block diagram of a first embodiment variant;

FIG. 2 shows a schematic perspective view of an intermediate storage module according to a second embodiment variant;

FIG. 3 shows a schematic perspective view of an intermediate storage module according to a third embodiment variant;

FIG. 4 shows a detailed circuit diagram of the embodiment variant according to FIG. 1;

FIGS. 5 to 7 show different power supply devices for electric motors of a vehicle according to the prior art.

### DETAILED DESCRIPTION

According to various embodiments, a vehicle having a power supply device for an electric motor and a method for supplying power to the electric motor are provided. Also disclosed is a method for manufacturing an intermediate storage device for the vehicle power supply device. For this purpose, the vehicle has a vehicle battery, an intermediate storage device and a converter for supplying power to the electric motor, wherein the intermediate storage device is arranged between the vehicle battery and the converter. The intermediate storage device has an intermediate storage module with an integral discharge device, wherein the discharge device converts the stored electrical energy into thermal energy when the intermediate storage device is discharged.

The subject matter according to various embodiments has the advantage that the discharge device is an integral part of the intermediate storage module. This ensures that no external connections are required to ensure a discharging of the storage components of the intermediate storage device, especially as the discharge device is automatically in the discharged state during the quiescent state of the vehicle and also during any interruptions of the vehicle operation, e.g. due to a vehicle accident. Only during running mode does the discharge device itself interrupt the discharge, such that the intermediate storage device can perform its function, specifically that of ensuring a decoupling takes place between battery and the converter for the power supply to the motor.

A coil or preferably a DC link capacitor can be used as an intermediate store in the intermediate storage device. This DC link capacitor is preferably part of an intermediate storage module that has a common housing in which are arranged components such as the DC link capacitor, an electrical resistor for the purpose of converting the stored electrical energy into thermal energy, a discharge switching element that has an open position during the charging and storage process and a closed position during the discharging of the DC link capacitor, and an electronic driver for holding the discharge switching element open during the charging and storage process and for closing the same if the vehicle engine fails or is turned off.

By means of said intermediate storage module a compact intermediate storage device is advantageously realized, which intermediate storage device also ensures that the discharge device is always switched on in the absence of a running mode, and is only deactivated when the running mode starts. As already explained in the introduction, the capacitance of the DC link capacitor is considerable, and therefore the DC link capacitor has a correspondingly large surface area or dimensions.

In an embodiment variant, the DC link capacitor is a foil capacitor and the electrical resistor is a foil resistor which interacts with the discharge device. For this purpose the foil capacitor can have two large-surface collector electrodes and carry the foil resistor on at least one of the electrodes, said foil resistor being arranged in a planar manner on one of the electrodes. Such a planar arrangement can also be structured, preferably as a meander-shaped resistor structure. Furthermore, an integrated circuit comprising the discharge switching element and the electronic driver can be arranged on one of the collector electrodes of the foil capacitor.

A specific form of the DC link capacitor is produced when a stacked multilayer capacitor or a wound capacitor or a ceramic capacitor is used. The outer electrodes of such capacitors have different shapes, planar smooth collector electrodes being preferred, such as those which a stacked multilayer capacitor or ceramic capacitor may have. However, it is also possible to integrate discharge devices on cylindrical or cup-shaped surfaces of collector electrodes, such as those provided in the case of the wound capacitor or an electrolytic capacitor. Even if an A1 electrolytic capacitor is used as a DC link capacitor, it is possible to arrange a corresponding discharge structure on the cup-shaped outer electrode of the A1 electrolytic capacitor. These structures are preferably insulated from the carrying electrode by an insulating layer.

The actual converter which converts electrical energy into thermal energy and is preferably an electrical resistor can also be mounted in an insulated manner on the carrying surface of a collector electrode of a capacitor. In an embodiment variant such an electrical resistor is a thin-film resistor or a thick-film resistor. In the case of thin-film resistors, an insulating layer is applied to the collector electrode and a thin metal layer is provided on top of this, said thin metal layer then possibly being patterned in addition with a meander-shaped structure, for example. Thick-film resistors are preferably applied to a ceramic substrate, this in turn being materially bonded onto the carrying collector electrode of the DC link capacitor.

It is also advantageous to provide a temperature-monitored resistor in order to ensure that overheating of the resistor is prevented in the case of malfunction. Moreover, provision is made for using a resistor which has a positive temperature coefficient, namely a so-called PTC resistor for converting the stored energy into thermal energy. This has the advantage that the resistor protects itself against overheating in the event of malfunction in that its resistance value increases as the temperature rises, and automatically reduces the discharge current to an acceptable value.

A method for manufacturing an intermediate storage device can comprise the following method steps. Firstly a DC link capacitor with at least one surface collector electrode is provided. Then an insulating layer is applied to the collector electrode. A wiring structure can be arranged on this insulating layer. An electrical resistor is then mounted onto a region of the insulating layer and connected to the wiring structure, and finally a discharge switching element is fixed on the insulating layer and connected to the wiring structure. Finally still, an electrical driver can also be arranged on the insulating layer, and must likewise be connected to the wiring structure.

This method has the advantage that, as a result of manufacturing the intermediate storage device, an intermediate storage module is produced such that all components are surface-mounted on one of the collector electrodes of the DC link capacitor as in the case of a printed circuit board. This intermediate storage device is therefore a compact module which merely lacks a housing. This housing can be realized by embedding the components, which are connected to form a module, into a plastic packaging compound. However, the housing can also be designed as a cavity housing, using corresponding intermediate insulation, wherein the cavity of the housing is occupied by the components described above.

A method for supplying power to an electric motor of a vehicle has the following method steps. When starting and during the operation of the vehicle, a discharge switching element of a capacitive intermediate store is initially opened. In a currentless state, i.e. when the vehicle is not in operation or has come to a standstill due to an accident, for example, the discharge switching element is in an electrically conductive closed position, such that the DC link capacitor is effectively short-circuited via a resistor which converts electrical energy into thermal energy.

The opening of this discharge switching element makes it then possible, interacting with a vehicle battery, to charge or operate the capacitive link store. The stored energy can be converted into an alternating current by a converter, in order to supply the electric motor. When the vehicle engine is turned off or stopped, a discharging of the electrical energy of the capacitive intermediate store is activated as a result of switching in an electrical resistor which is arranged together with the DC link capacitor in a common intermediate storage module.

The switching-in of an electrical resistor is effected by means of a discharge switching element which is integrated in the intermediate storage module, and an electronic driver. During the subsequent discharging process of the intermediate storage device, the stored electrical energy which was temporarily stored as electrical energy in a DC link capacitor of the intermediate storage device is converted into thermal energy.

During the charging and storage process the discharge switching element assumes an open position, and during the discharging of the DC link capacitor the discharge switching element assumes a closed position. In this case an electronic driver keeps the discharge switching element open during the charging and storage process, while the discharge switching element automatically returns to the closed position if the vehicle engine fails or is turned off.

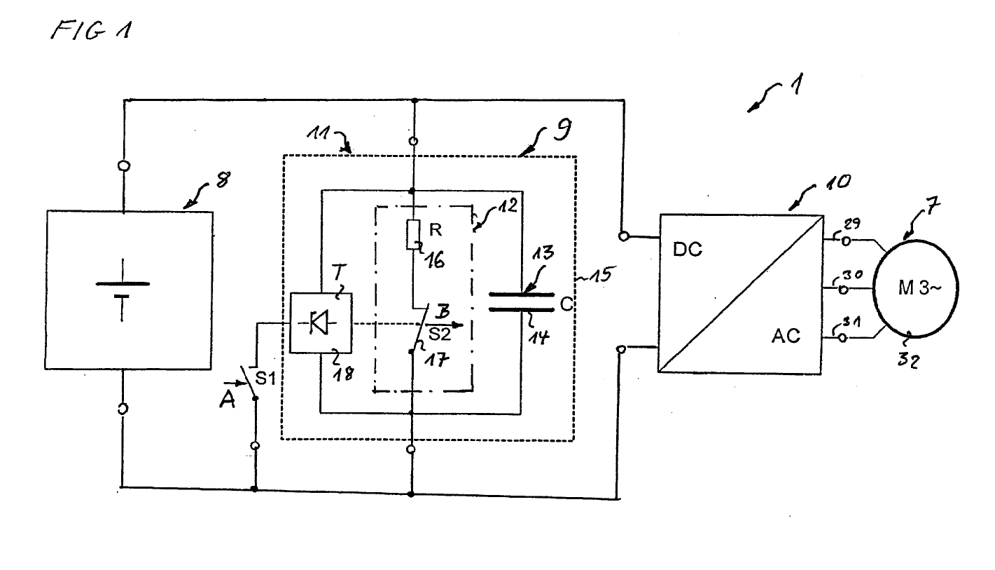

FIG. 1 shows a schematic block diagram of a first embodiment variant. In this first embodiment variant, the vehicle has a power supply device 1 for an electric motor 7 which in this embodiment variant is a three-phase motor 32. The three-phase motor 32 is supplied with power with the aid of three phases via the supply lines 29, 30 and 31 by a frequency converter 10 which converts a direct current DC into three-phase alternating current AC. The frequency converter 10 is attached to a vehicle battery 8 which delivers DC voltages higher than 60 V and preferably comprises lithium ion batteries.

For the purpose of decoupling the frequency converter 10 and the vehicle battery 8, a so-called link comprising a DC link capacitor 14 is arranged between the two. This link forms an intermediate storage device 9 which has a plurality of electronic components in a compact sealed housing 15 in this first embodiment variant. While the DC link capacitor 14 performs a smoothing and decoupling function, it is electrostatically charged and stores electrical energy as an intermediate store 13 for as long as the vehicle is operating.

If the vehicle and vehicle engine are turned off or stopped, a battery switching element S₃ moves from a closed position to an open position, such that the vehicle battery is separated from the intermediate storage device 9. However, the electrical energy that is stored in the intermediate store 13 must now be removed in a matter of seconds. For this purpose the first embodiment variant has a discharge device 12 which essentially consists of an electrical resistor 16 in series with a discharge switching element 17, this being also identified as S₂. This discharge switching element 17 is conductive, i.e. in a closed position, for as long as an electrical charge is stored on the DC link capacitor 14 and the vehicle is not operating. Only when the capacitor is discharged does the charge switching element 17 move to an open position, for which purpose a driver T or trigger for the discharge switching element 17 is arranged in the housing 15.

This driver 18 is for its part controlled via a switch S₁, the switch S₁ moving in the arrow direction A to a closed position when the vehicle is started and is in operation, while the discharge switching element 17 is simultaneously held in an open position (arrow direction B) such that charging of the DC link capacitor 14 is made possible. Components of the circuit in the common housing 15 form an intermediate storage module 11 with an integral discharge device 12. Furthermore, the integral discharge device 12 can be fixed to one of the walls or onto a circuit board or onto one of the electronic components of the intermediate storage module 11 in the interior of the housing 15.

The circuit shown in FIG. 1 therefore ensures a continuous discharging of the DC link capacitor 14 via the electrical resistor 16 and the discharge switching element 17 when the operation of the vehicle is stopped or interrupted. The driver 18 switches the discharge switching element 17 to conductive when a Zener diode voltage is reached. However, the discharging is interrupted via the switch S₁ as soon as the vehicle is started. By virtue of this arrangement, as shown in FIG. 1, the discharging of the intermediate storage capacitor 14 is also ensured if the trigger is interrupted via the switch S₁.

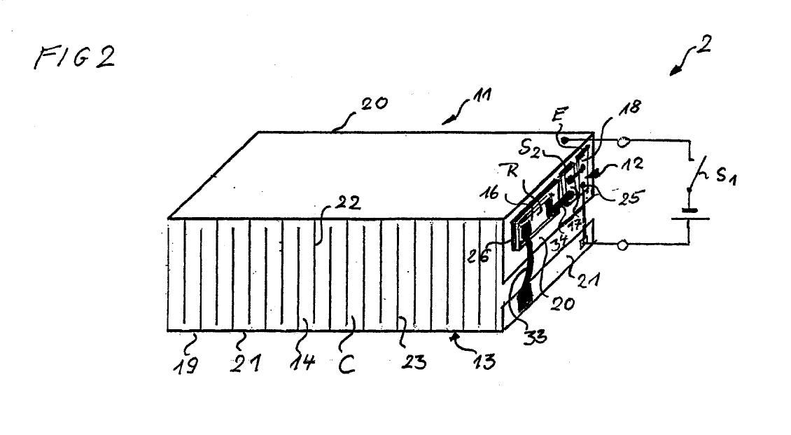

FIG. 2 shows a schematic perspective view of an intermediate storage module 11 according to a second embodiment variant. In this second embodiment variant the intermediate storage module 11 is based on a foil capacitor 19 as a DC link capacitor 14. This foil capacitor 19 is constructed as a stacked multilayer capacitor, wherein insulating foils metallized on one side are stacked one on top of the other layer-by-layer such that storage electrodes 22 are electrically connected to a collector electrode 20 on the top side of the stacked multilayer capacitor and storage electrodes 23 interact with a collector electrode 21 on the underside of the stacked multilayer capacitor.

In this embodiment variant the two collector electrodes 20 and 21 are bent over the side edge onto an end face of the stacked multilayer capacitor, where they carry both the control device or driver 18 and the discharge device composed of a series circuit of a resistor 16 and a discharge switching element 17. While the discharge switching element 17 directly contacts the collector electrode 20 of the DC link capacitor 14 via its rear-side drain electrode, the resistor 16 is embodied as a ceramic resistor and is mounted on the collector electrode 20 in an insulated manner via an insulating layer 26.

If S₁ is open because the vehicle is not operating, the driver 18 switches the switch S₂ through for as long as storage energy is still present on the DC link capacitor 14, thereby discharging the collector electrode 20 via the switching element S₂ and the resistor 16, and the second collector electrode 21 via the connecting leads 33 and 34. In this way the energy stored in the link store 14 is converted into thermal energy in the charging resistor 16. Since ceramic resistors in the form of thick-film resistors can be manufactured so as to have a small surface area and to be compact, the front face of the bent collector electrode 20 is sufficient for the complete discharge device for the DC link capacitor 14 to be arranged there.

Furthermore it is possible, through appropriate composition of the sintering material of the thick-film resistor, also to manufacture a resistor which has positive temperature coefficients and which, by virtue of said positive temperature coefficients, raises its resistance value as the temperature increases, and therefore such PCT resistors are automatically protected against overheating. This is not possible in the case of a thin-film resistor, which is used in the next embodiment variant as shown in the next figure. In such a case the charging resistor requires thermal monitoring. This thermal monitoring can be integrated into the electronic driver.

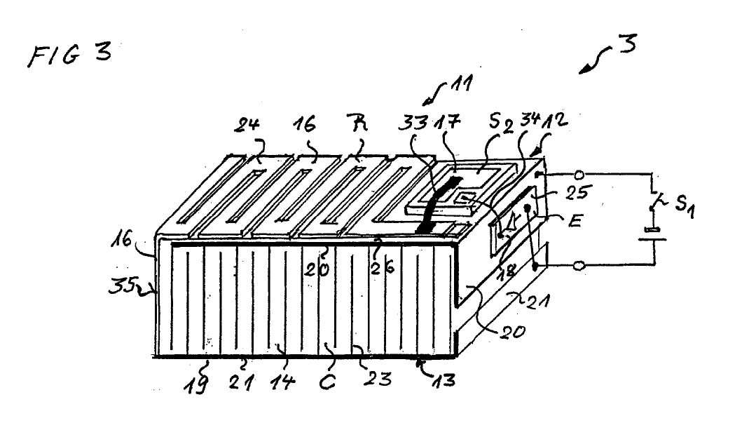

FIG. 3 shows a schematic perspective view of an intermediate storage module 11 according to a third embodiment variant. What is once again realized in this embodiment variant is a compact intermediate storage module 11 having a stacked multilayer capacitor as a DC link capacitor 14. Instead of stacked multilayer capacitors, however, it is also possible to use capacitors in the form of wound capacitors or electrolytic capacitors. In such cases the integral discharge device can be accommodated on the cup-shaped or cylindrical electrodes of such DC link capacitors.

In the exemplary embodiment variant shown in FIG. 3, the collector electrode 20 and an end face 35 of the stacked multilayer capacitor are coated by an insulating layer 26 and the meander-shaped thin-film resistor 16 is arranged on this insulating layer, both on the top side of the stacked multilayer capacitor with the collector electrode 20 and on the end face 35, such that this discharge resistor 16 at one end contacts the collector electrode 21 which is arranged on the rear side of the stacked multilayer capacitor.

The other end of the discharge resistor 16 is connected via a connecting lead 33 to an electrode of the discharge switching element 17, whose second electrode on the rear side of the discharge switching element 17 contacts the collector electrode 20. For as long as an electrical charge is still stored in the DC link capacitor 14, the control electrode of the discharge switching element 17 is driven via the connecting lead 34 in such a way that the collector electrode 20 is connected via the switching element S₂ and the resistor R to the collector electrode 21 on the rear side. Therefore, independently of external influences, the electrical energy stored in the DC link capacitor 14 is converted into heat in the discharge resistor R and the DC link capacitor 14 is discharged. Conversely, when the switch S₁ is closed, the discharge switching element 17 is driven via the connecting lead 34 in such a way that it moves to an open position and the normal operation of the DC link capacitor 14 is started.

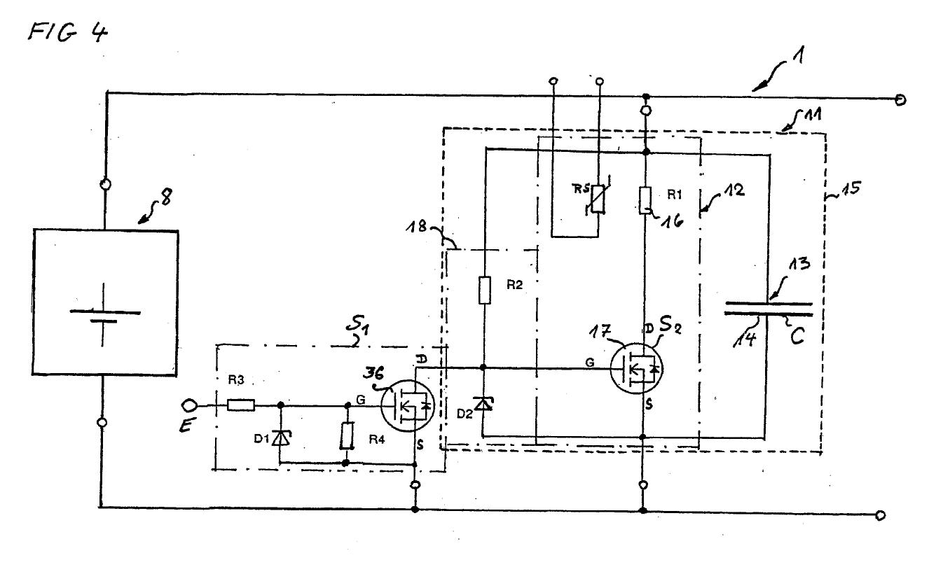

FIG. 4 shows a detailed circuit diagram of the embodiment variant according to FIG. 1. The switch S₁ is realized in this case by means of a low-voltage MOSFET 36. This MOSFET 36 becomes conductive and hence moves to a closed position when a control voltage for the gate G of the MOSFET 36 is applied to the input E. This control potential is limited by a Zener diode D₁ in this case. Consequently if a corresponding control potential is applied to the input E as a result of the vehicle being started, the drain D of the MOSFET 36 is in this case pulled to ground potential, with the result that at the gate G of the discharge switching element 17, which is likewise embodied as a MOSFET, there is insufficient control voltage present to keep the discharge switching element in a closed position. Accordingly, the discharge switching element now opens with the vehicle being in operation and the DC link capacitor 14 can perform its full function.

As soon as the vehicle operation is turned off and therefore at the input E there is no switching potential present at the MOSFET 36, the latter moves to an open position and becomes non-conductive, with the result that a switching voltage is now applied to the gate G of the discharge switching element 17 via a high-impedance resistor R₂, said switching voltage corresponding to the Zener diode voltage of the Zener diode D₂ in the intermediate storage module 11. This Zener voltage is dimensioned such that the discharge switching element 17 now switches through or becomes conductive for as long as a storage charge is present on the DC link capacitor 14.

It is therefore possible for a discharge current to flow via the resistor 16, which converts the stored energy into heat, until the discharge switching element 17 no longer has sufficient control voltage for the gate, and therefore the discharge switching element 17 moves to its open position after the DC link capacitor 14 is discharged. This open position is maintained during the charging and storage process as soon as a sufficient control signal is present at the input E of the circuit S. This ensures that, even if the circuit S₁ fails, the DC link capacitor 14 is automatically discharged via the discharge switching element 17 in any event.

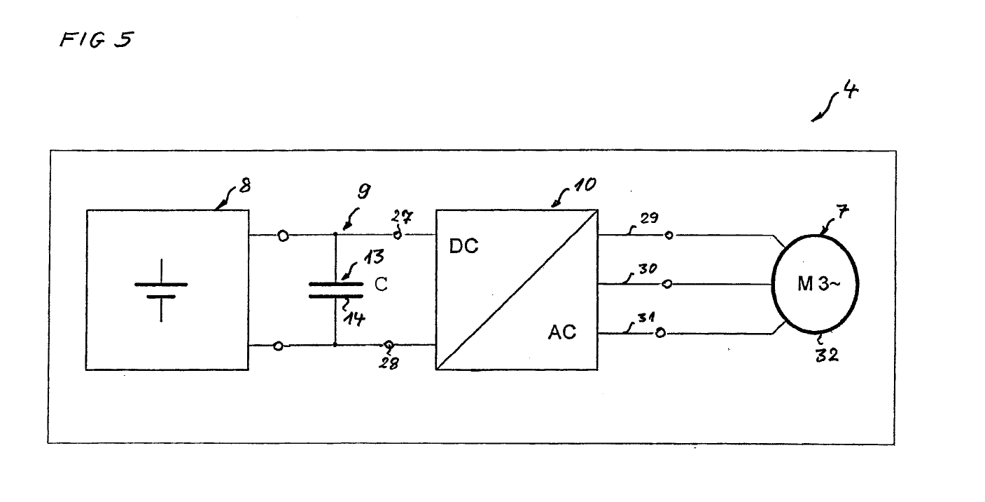

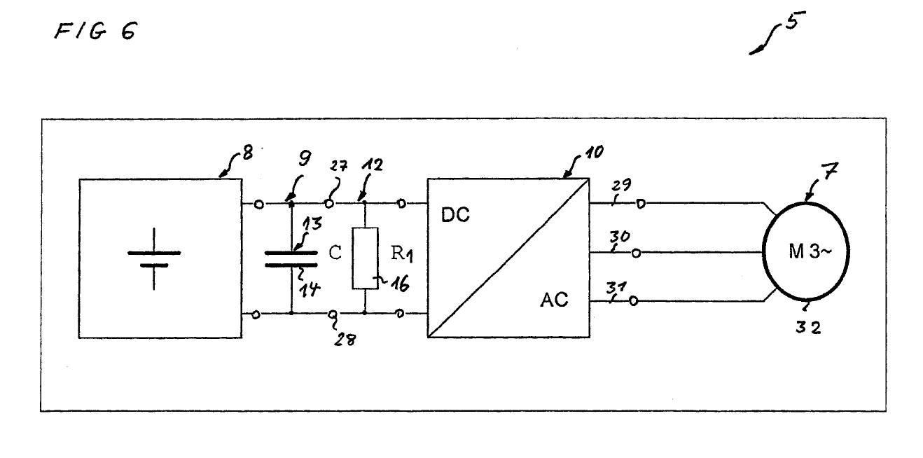

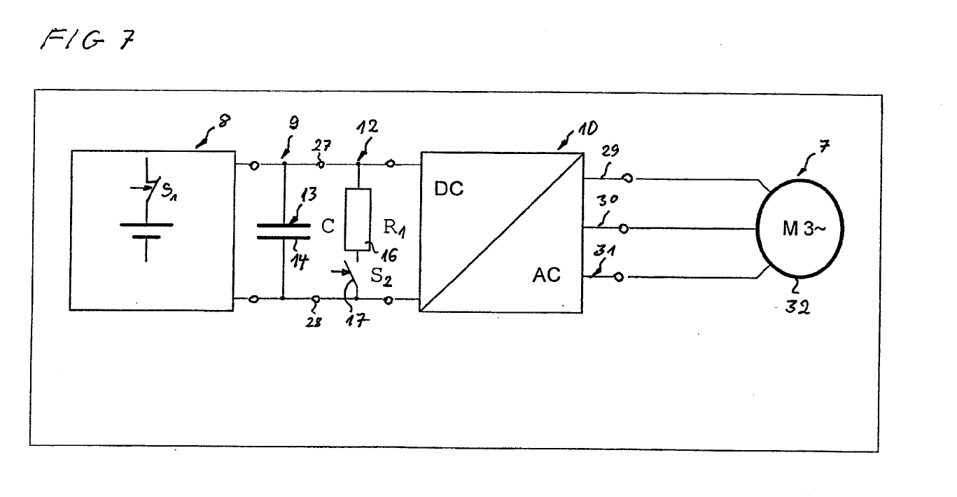

FIGS. 5 to 7 show different power supply devices 4 to 6 for electric motors 7 of a vehicle according to the prior art, as already discussed in the introduction, and therefore in order to avoid repetition a further description is omitted at this point.

What is claimed is:

1. A vehicle having a power supply device for an electric motor, comprising:
a vehicle battery;
an intermediate storage device;
a converter for supplying power to the electric motor;
wherein the intermediate storage device is arranged between the vehicle battery and the converter, and
the intermediate storage device has an intermediate storage module with an integral discharge device, wherein said discharge device converts the stored electrical energy into thermal energy when the intermediate storage device is discharged.

2. The vehicle according to claim 1, wherein
the intermediate storage device has a DC link capacitor as an intermediate store.

3. The vehicle as according to claim 2, wherein
the intermediate storage module has a common housing for the following components: the DC link capacitor, an electrical resistor, a discharge switching element which has an open position during the charging and storage process and a closed position during the discharging of the DC link capacitor, an electronic driver for holding the discharge switching element open during the charging and storage process and for closing the same if the vehicle engine fails or is turned off.

4. The vehicle as according to claim 2, wherein
the DC link capacitor is a foil capacitor and the electrical resistor is a foil resistor which interacts with the discharge device.

5. The vehicle as according to claim 4, wherein
the foil capacitor has two large-surface collector electrodes and corresponding storage electrodes, and at least one electrode carries a foil resistor which is arranged in a planar manner on one of the electrodes in a meander-shaped structure.

6. The vehicle as according to claim 5, wherein
an integrated circuit comprising the discharge switching element and the electronic driver is arranged on one of the collector electrodes.

7. The vehicle according to claim 2, wherein
the DC link capacitor is a stacked multilayer capacitor or a wound capacitor or a ceramic capacitor.

8. The vehicle according to claim 2, wherein
the DC link capacitor is an A1 electrolytic capacitor.

9. The vehicle according to claim 2, wherein
the electrical resistor is a thin-film resistor or a thick-film resistor on ceramic.

10. A method for manufacturing an intermediate storage device comprising the following method steps:
providing a DC link capacitor comprising at least one surface collector electrode;
applying an insulating layer to the collector electrode;
applying a wiring structure to the insulating layer;
mounting an electrical resistor on a region of the insulating layer and connecting it to the wiring structure;
mounting a discharge switching element on the insulating layer and connecting it to the wiring structure;
mounting an electronic driver on the insulating layer and connecting it to the wiring structure.

11. A method for supplying power to an electric motor of a vehicle, comprising the following method steps:
opening a discharge switching element of a capacitive intermediate store;
charging the capacitive intermediate store while interacting with a vehicle battery;
converting the stored energy into an alternating current and supplying power to the electric motor;
disconnecting or stopping the vehicle engine and discharging the electrical energy of the capacitive intermediate store by switching in an electrical resistor which is arranged together with the DC link capacitor in a common intermediate storage module.

12. The method according to claim 11, wherein
the switching-in of an electrical resistor is effected by means of a discharge switching element which is integrated in the intermediate storage module and an electronic driver.

13. The method according to claim 11, wherein
during the discharging process of the intermediate storage device, the stored electrical energy is converted into thermal energy.

14. The method according to claim 10, wherein
electrical energy is temporarily stored in a DC link capacitor.

15. The method according to claim 14, wherein
a discharge switching element assumes an open position during the charging and storage process and a closed position when discharging the DC link capacitor, wherein an electronic driver holds the discharge switching element open during the charging and storage process and holds it closed if the vehicle engine fails or is turned off.
